(19) United States
(12) Patent Application Publication
(10) Pub. No.: US 2017/0024031 A1
(43) Pub. Date: Jan. 26, 2017

(54) DISPLAY SYSTEM, DISPLAY DEVICE, AND DISPLAY CONTROL METHOD

(71) Applicant: SEIKO EPSON CORPORATION, Tokyo (JP)

(72) Inventor: Yuki UEDA, Matsumoto-Shi (JP)

(73) Assignee: SEIKO EPSON CORPORATION, Tokyo (JP)

(21) Appl. No.: 15/302,333

(22) PCT Filed: Apr. 15, 2015
(86) PCT No.: PCT/JP2015/002085

§ 371 Date: Oct. 6, 2016

(30) Foreign Application Priority Data
Apr. 18, 2014 (JP) 2014-086212
Apr. 18, 2014 (JP) 2014-086216

(51) Int. Cl. G06F 3/041; G09G 5/00

(52) U.S. Cl. CPC G06F 3/041; G09G 5/003

(57) ABSTRACT

In a display system which includes a mobile terminal as an input device and a projector as a display device, the mobile terminal includes a control unit which detects an operation performed on a touch screen and generates coordinate information indicative of an operation location on the touch screen, and a wireless communication unit which transmits the coordinate information generated by the control unit, and the projector includes a wireless communication unit which receives the coordinate information, and a control unit which generates an image based on the received coordinate information and displays the image on a screen.

### TECHNICAL FIELD

The present invention relates to a display system, a display device, and a display control method.

### BACKGROUND ART

In recent years, so-called an interactive whiteboard, which is used in the field of education, presentation, or the like, has been spread. The interactive whiteboard enables a user to write to content while displaying the content of a document or the like. For example, in PTL 1, a traveling locus of a pen, which is moved in a board portion of an electronic blackboard, is formed as an image, and is displayed in the board portion. In addition, PTL 1 discloses a digital pen which includes a pen that is an input device, and a main body unit that receives a signal from the pen. In a case in which the user draws a letter or a figure using the pen, the main body unit detects the traveling locus of the pen based on the signal which is emitted from the pen, and generates digital data of an image which is the same as the drawn letter or the figure. In addition, a wireless LAN terminal is mounted on the main body unit, and the wireless LAN terminal transmits digital data generated by the main body unit to the board portion of the electronic blackboard, and displays the letter or the figure, which is drawn using the digital pen, on the board portion.

### CITATION LIST

### Patent Literature

PTL 1: JP-A-2010-284797

### SUMMARY OF INVENTION

### Technical Problem

However, in a case in which the traveling locus of the pen, which is moved in the board portion of the electronic blackboard, is formed and displayed in the board portion, it is difficult to input the letter, the figure, or the like in a location which is separated from the board portion in which the image is displayed. In addition, in a case in which the letter or the figure is displayed in the board portion of the electronic blackboard using a digital pen which has a wireless communication function, the digital pen should detect a traveling locus of the pen and generate digital data of the image, and thus processing loads of the digital pen increases. In addition, it is difficult to understand corresponding relationship between an area, in which it is possible to detect pen input in the digital pen, and a display area of the board portion of the electronic blackboard.

The invention has been made in view of the circumstances, and an object of the invention is to provide a display system, a display device, and a display control method in which processing loads of the input device is reduced in a configuration in which an input device and a display device are separated.

### Solution to Problem

In order to accomplish the above object, a display system according to the invention includes: a display device; and an input device, the display device includes a first communication unit that receives coordinate information which indicates an operation location on an operation surface of the input device; and a display control unit that generates an image based on the coordinate information, which is received by the first communication unit, and displays the image on a first display surface, and the input device includes a generation unit that detects an operation which is performed on the operation surface, and generates the coordinate information; and a second communication unit that transmits the coordinate information which is generated by the generation unit.

According to the configuration, in a configuration in which the input device and the display device are separated, it is possible to reducing the processing loads of the input device.

In the display system, the display device includes a storage unit that stores correspondence information for deciding correspondence between a display area of a second display surface included in the input device and a display area of the first display surface, and the display control unit generates the image based on the coordinate information according to the correspondence information, and displays the image on the first display surface.

According to the configuration, in the display device, it is possible to generate the image based on the coordinate information, which is transmitted from the input device according to the correspondence information, and to display the image on the first display surface.

In the display system, the first communication unit transmits image data to the input device, the second communication unit receives the image data, and the input device includes a display unit that displays an image based on the image data, which is received in the second communication unit, on a second display surface which is disposed to be superimposed on the operation surface.

According to the configuration, in a case in which the operation is performed on the second display surface, on which the image is displayed, it is possible to perform the operation for the operation surface and it is possible to perform an intuitive operation in the mobile terminal.

In the display system, the display device transmits the image data corresponding to at least a part of the image, which is displayed on the first display surface, to the input device as the image data.

According to the configuration, it is possible to display the image data corresponding to a part of the image, which is displayed on the first display surface, in the input device.

In the display system, the display device transmits image data corresponding to a partial image, which is selected from the image that is displayed on the first display surface, to the input device.

According to the configuration, it is possible to display the partial image, which is selected from the image that is displayed on the first display surface, in the input device.

In the display system, the display device transmits image data, which indicates the display area of the first display surface on which the image based on the coordinate information is displayed, to the input device as the image data.

According to the configuration, it is possible to display the image data, which indicates the display area of the first display surface on which the image is displayed, in the input device.

In the display system, in a case in which the coordinate information is operation information for enlarging or reducing the image, the display control unit enlarges or reduces the image which is displayed on the first display surface according to the operation information.

According to the configuration, it is possible to enlarge or reduce the image, which is displayed on the first display surface, by performing the operation from the input device.

According to the invention, there is provided a display device, which displays an image based on image data on a first display surface, including: a first communication unit that receives coordinate information on a second display surface, which is included in an external device, the coordinate information being transmitted from the external device; a storage unit that stores correspondence information for deciding correspondence between a display area of the second display surface and a display area of the first display surface; and a display control unit that generates an image based on the coordinate information according to the correspondence information, and displays the image on the first display surface.

According to the configuration, in a case in which the image based on the operation information that is input by the external device is displayed in the display device, it is possible to reduce the processing loads of the external device.

A display control method according to the invention is a display control method in a display system which includes an input device and a display device, the method including: a generation step of detecting an operation performed on an operation surface in the input device, and generating coordinate information of an operation location on the operation surface; and a transmission step of transmitting the coordinate information generated in the generation step, a reception step of receiving the coordinate information in the display device; and a display step of generating an image based on the coordinate information which is received in the reception step, and displaying the image on the first display surface.

According to the configuration, in the configuration in which the input device and the display device are separated, it is possible to reducing the processing loads of the input device.

In order to accomplish the object, a display system according to the invention includes: a display device; and an input device, the display device includes a first display unit that displays an image based on image data on a first display surface; and a first communication unit that transmits the image data corresponding to at least a part of the image, which is displayed on the first display surface, to the input device, the input device includes an operation surface that receives an operation; a detection unit that detects the operation which is performed on the operation surface; a second display unit that displays an image based on the image data corresponding to at least a part of the image, on the second display surface; and a second communication unit that transmits operation data corresponding to an operation location, which is detected by the detection unit, to the display device while the image data corresponding to at least a part of the image is being displayed on the second display surface, and the display device displays the image based on the operation data on the first display surface.

According to the configuration, in the configuration in which the input device and the display device are separated, it is possible to perform intuitive operation input by the input device.

In the display system, the display device associates the image data corresponding to at least a part of the image, which is transmitted to the input device, with a display location on the first display surface, and stores an association result, and displays the image based on the operation data in the display location of the first display surface which is associated with the image data corresponding to at least a part of the image.

According to the configuration, it is possible to display the image according the operation, which is received by the input device, in the display location of the image which is transmitted to the input device.

In the display system, a plurality of input devices are provided, the display device associates the image data corresponding to at least a part of the image, which is transmitted to each of the input devices, with the display location on the first display surface, and stores an association result, and, in a case in which the operation data is received from the input device, displays the image based on the operation data in the display location on the first display surface that is associated with the image data corresponding to at least a part of the image which is transmitted to each of the input devices.

According to the configuration, it is possible to display the image based on the operation data in the display location on the first display surface according to the image data which is transmitted to each of the input devices.

In the display system, the input device transmits coordinate information on the operation surface, which indicates the operation location that is detected by the detection unit, to the display device as the operation data, and the display device generates an image based on the coordinate information which is received from the input device, and displays the image on the first display surface.

According to the configuration, in a case in which the input device transmits the coordinate information, the input of which is received, to the display device without change, the image based on the coordinate information is displayed in the display device, and thus it is possible to reduce the processing loads of the input device.

In the display system, the input device generates image data, which includes at least one of a letter and a figure based on the operation that is performed on the operation surface, and transmits the generated image data to the display device as the operation data.

According to the configuration, it is possible to generate the image data according to the operation, which is received in the input device, and to display the image data in the display device.

In the display system, the input device transmits the generated image data to the display device by generating the image data which is superimposed on the image data corresponding to at least a part of the image.

According to the configuration, it is possible to superimpose the image, which is generated based on the received operation of the input device, on the image which is displayed in the display device, and to display the superimposed image.

A display device according to the invention is a display device, which displays an image based on image data on a first display surface, and includes: a storage unit that stores information which is acquired by associating the image data corresponding to at least a part of the image that is displayed on the first display surface with a display location on the first display surface; a first communication unit that transmits the image data corresponding to at least a part of the image to an external device, and receives operation information of an operation, which is received in the external device, from the external device; and a display unit that displays an image according to the operation information in the display location on the first display surface.

According to the configuration, it is possible to display the image according to the operation, which is received in the external device, in the display location of the image which is transmitted to the external device.

A display method according to the invention is a display method in a display system, which includes a display device and an input device, the display method including: displaying an image based on image data on a first display surface in the display device; transmitting the image data corresponding to at least a part of the image, which is displayed on the first display surface, to the input device; displaying an image based on the image data corresponding to at least a part of the image on the second display surface in the input device; detecting an operation which is performed on an operation surface that receives the operation while the image data corresponding to at least a part of the image is being displayed on the second display surface; transmitting operation data corresponding to a detected operation location to the display device; and displaying an image based on the operation data on the first display surface in the display device.

According to the configuration, in the configuration in which the input device and the display device are separated, it is possible to perform intuitive operation input by the input device.

### Advantageous Effects of Invention

According to the invention, in a configuration in which the input device and the display device are separated, there are advantages in that processing loads of the input device is reduced, and, further, it is possible to perform intuitive operation input by the input device.

### BRIEF DESCRIPTION OF DRAWINGS

FIG. 1 is a configuration diagram illustrating an example of a configuration of a display system.

FIG. 2 is a block diagram illustrating an example of a configuration of a mobile terminal according to a first embodiment.

FIG. 3 is a block diagram illustrating an example of a configuration of a projector.

FIG. 4 is a diagram illustrating an example of an image which is displayed on a screen SC.

FIG. 5 is a diagram illustrating a state in which an image, which is input by the mobile terminal, is projected onto the screen by the projector.

FIG. 6 is a flowchart illustrating the processing procedure of the projector and the mobile terminal.

FIG. 7 is a diagram illustrating an example of a coordinate conversion table.

FIG. 8 is a block diagram illustrating an example of a configuration of a mobile terminal according to a third embodiment.

FIG. 9 is a block diagram illustrating an example of a configuration of a projector.

FIG. 10 is a diagram illustrating a state in which an image, which is input by the mobile terminal, is projected onto a screen by the projector.

FIG. 11 is a flowchart illustrating a processing procedure of the projector and the mobile terminal.

FIG. 12 is a block diagram illustrating an example of a configuration of a mobile terminal according to a fourth embodiment.

### DESCRIPTION OF EMBODIMENTS

### First Embodiment

Hereinafter, a first embodiment of the invention will be described with reference to the accompanying drawings.

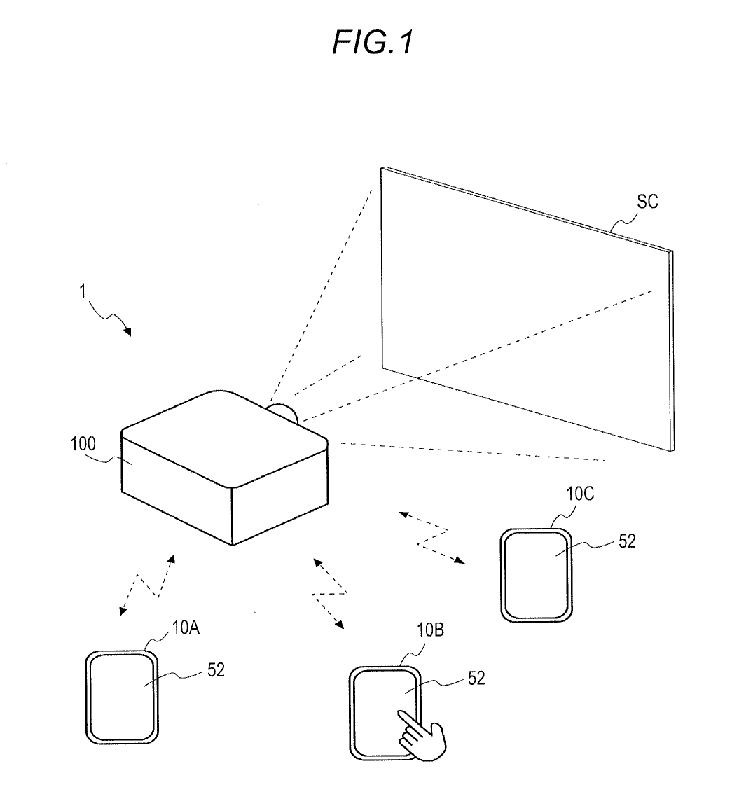

FIG. 1 illustrates a schematic configuration of a display system 1 according to the first embodiment. The display system 1 according to the first embodiment includes a plurality of mobile terminals 10A, 10B, 10C, . . . , as input devices, and a projector 100 as a display device. Meanwhile, although FIG. 1 illustrates three mobile terminals 10A, 10B, and 10C, the number of mobile terminals 10A, 10B, and 10C is not limited to three. The number of mobile terminals may be one or may be four or more. In addition, in a case in which it is not necessary to distinguish between the mobile terminals 10A, 10B, and 10C, the mobile terminals are expressed as mobile terminals 10.

The mobile terminals 10 and the projector 100 are connected to be able to transmit and receive various data through a wireless communication method. With regard to the wireless communication method, it is possible to use, for example, wireless local area communication methods, such as a wireless Local Area Network (LAN), Bluetooth (registered trademark), an Ultra Wide Band (UWB), and infrared communication, and a wireless communication method using a mobile telephone line. It is possible for the projector 100 to access the plurality of mobile terminals 10 and to communicate with the mobile terminals 10.

The mobile terminal 10 is a small device which is operated by a user in hand, and includes, for example, a mobile telephone, such as a smart phone, and a device such as a tablet terminal or a Personal Digital Assistant (PDA). It is possible to operate the mobile terminal 10 in such a way that a user contact a finger to a surface of a display panel (second display surface) 52 and causes a touch screen (operation surface) 53 to detect a contact location, in addition to perform an operation on an operator such as a switch.

The projector 100 is a device which projects an image onto a screen SC (first display surface). The screen SC, onto which the image is projected by the projector 100, is substantially erected, and a screen surface has, for example, a rectangular shape. It is possible for the projector 100 to project moving images onto the screen SC and continuously project still images onto the screen SC.

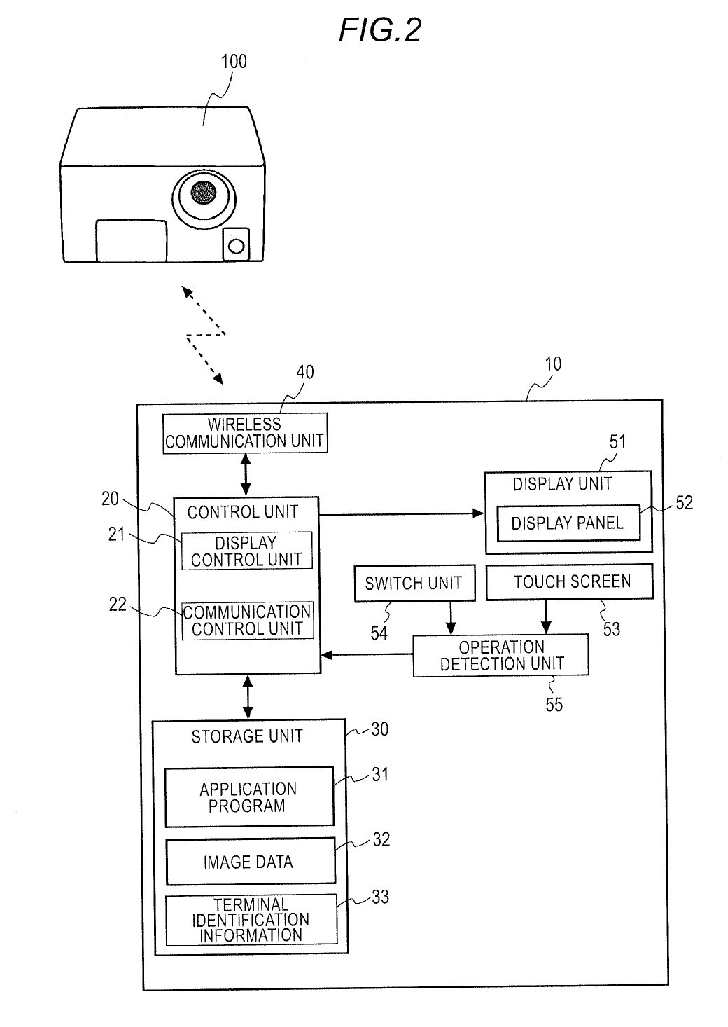

A configuration of the mobile terminal 10 will be described. FIG. 2 illustrates an example of a functional configuration of the mobile terminal 10.

The mobile terminal 10 includes a control unit 20 that controls each unit of the mobile terminal 10. The control unit 20 includes a Central Processing Unit (CPU), a Read Only Memory (ROM), a Random Access Memory (RAM), and the like which are not illustrated in the drawing, and controls the mobile terminal 10 by executing a basic control program, which is stored in the ROM, by the CPU. In addition, the control unit 20 functions as a display control unit 21 and a communication control unit 22 (hereinafter, referred to as functional blocks), which will be described later, by executing an application program 31 which is stored in the storage unit 30.

The mobile terminal 10 includes a storage unit 30. The storage unit 30 is a non-volatile store device, such as a flash memory or an Electronically Erasable and Programmable Read Only Memory (EEPROM), and is connected to the control unit 20. The storage unit 30 stores various programs including the application program 31, image data 32 which is received from the projector 100, and the like. In addition, the storage unit stores terminal identification information 33. The terminal identification information 33 is data for identifying the mobile terminal 10 between the projector 100 and the mobile terminal, and, specifically, includes a serial number which is unique to each mobile terminal 10, an authentication code which is shared between the projector 100 and the mobile terminal, and the like in order to identify the individual mobile terminal 10.

The mobile terminal 10 includes a wireless communication unit (second communication unit) 40. The wireless communication unit 40 includes an antenna, a Radio Frequency (RF) circuit (not illustrated in the drawing), and the like, and is connected to the control unit 20. The wireless communication unit 40 is controlled by the control unit 20, and transmits and receives various data between the mobile terminal 10 and the projector 100 in conformity to the above-described wireless communication method.

The mobile terminal 10 includes a display unit (second display unit) 51. The display unit 51 includes a display panel 52, and is connected to the control unit 20. The display unit 51 draws a frame in a drawing memory, which is not illustrated in the drawing, according to a display resolution of the display panel 52 based on the image data, which is input from the control unit 20, and causes the display panel 52 to display an image based on the drawn frame.

In addition, the mobile terminal 10 includes a touch screen 53, a switch unit 54, and an operation detection unit (generation unit or detection unit) 55. The touch screen 53 detects a contact operation performed on the display panel 52, and outputs a location signal indicative of a detected operation location to the operation detection unit 55. The operation detection unit 55 generates coordinate information indicative of coordinates on the touch screen 53 based on the location signal which is input from the touch screen 53, and outputs the coordinate information to the control unit 20. In addition, the switch unit 54 includes an operator, such as a switch, and outputs the operation signal to the operation detection unit 55 in a case in which a switch is operated. The operation detection unit 55 generates operation information corresponding to an operated operator and outputs the operation information to the control unit 20 based on the operation signal which is input from the switch unit 54.

It is possible for the control unit 20 to detect the contact operation performed on the display panel 52, the operation of each operator including the switch, and an operation of moving the main body of the mobile terminal 10 based on the coordinate information or the operation information which is input from the operation detection unit 55.

Subsequently, the functional blocks of the control unit 20 will be described.

The display control unit 21 displays various screens on the display panel 52 by controlling the display unit 51.

The display control unit 21 reads the image data 32 from the storage unit 30 or outputs the image data, which is received through the wireless communication unit 40, to the display unit 51. The display unit 51 draws the frame according to the display resolution of the display panel 52 in the drawing memory, which is not illustrated in the drawing, based on the input image data, and drives the display panel 52 based on the drawn frame.

In addition, the display control unit 21 receives the input of the coordinate information from the operation detection unit 55. The display control unit 21 detects a unique operation of the operation performed on the touch panel based on the coordinate information which is input from the operation detection unit 55. For example, the display control unit 21 detects an operation, such as pinch-in or pinch-out, which is performed on the display panel 52. The pinch-in operation is an operation of making two fingers to be close to be clipped on the display panel 52, and the pinch-out operation is an operation of keeping away the two fingers on the display panel 52.

In a case in which the display control unit 21 detects the pinch-in operation, the pinch-out operation, or the like, the display control unit 21 generates touch operation information which indicates the detected operation, generates control data, which includes the generated touch operation information and the coordinate information that is input from the operation detection unit 55, and transmits the generated control information to the communication control unit 22.

The communication control unit 22 performs wireless communication with the projector 100 by controlling the wireless communication unit 40. After the communication control unit 22 is connected to the projector 100, the communication control unit 22 transmits the terminal identification information, which is read from the storage unit 151, or the information, which is passed from the control unit 20, to the projector 100 through the wireless communication unit 40. In addition, the communication control unit 22 stores data, such as the image data which is received from the projector 100, in the storage unit 30.

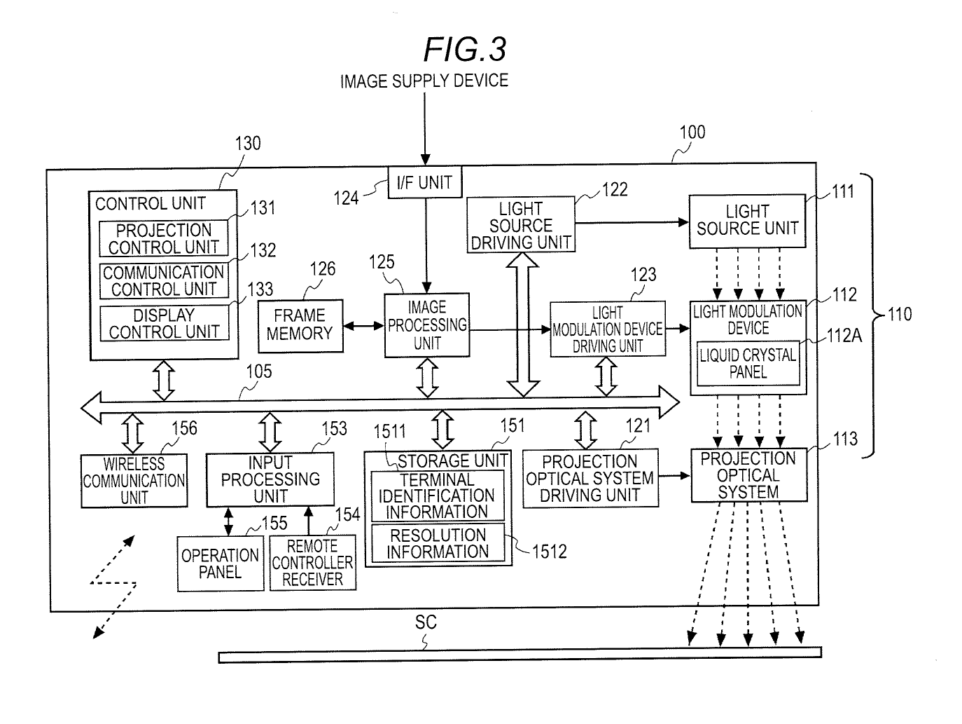

Subsequently, a configuration of the projector 100 will be described. FIG. 3 illustrates an example of a functional configuration of the projector 100.

The projector 100 includes an interface unit (hereinafter, abbreviated to an I/F) 124. The projector 100 is connected to an image supply device through the I/F unit 124. It is possible to use, for example, a DVI interface to which a digital video signal is input, a USB interface, a LAN interface, or the like as the I/F unit 124. In addition, it is possible to use, for example, an S-video terminal to which a composite video signal, such as NTSC, PAL, or SECAM, is input, an RCA terminal to which a composite video signal is input, a D-terminal to which a component video signal is input, or the like as the I/F unit 124.

Furthermore, it is possible to use a general-purpose interface, such as an HDMI connector, in conformity to the HDMI (registered trademark) standards as the I/F unit 124. In addition, the I/F unit 124 may be configured to include an A/D conversion circuit which converts an analog video signal into digital image data, and to be connected to the image supply device through an analog video terminal such as a VGA terminal. Meanwhile, the I/F unit 124 may transmit and receive the image signal through wired communication or may transmit and receive the image signal through wireless communication.

The projector 100 generally includes a projection unit (first display unit) 110 which forms an optical image, and an image processing system which electrically processes the image signal that is input to a projection unit 110. The projection unit 110 includes a light source unit 111, a light modulation device 112 which has a liquid crystal panel 112A, and a projection optical system 113.

The light source unit 111 includes a light source which includes a xenon lamp, an extra-high pressure mercury lamp, a Light Emitting Diode (LED), a laser, or the like. In addition, the light source unit 111 may include a reflector and an auxiliary reflector which guide light that is emitted from the light source to the light modulation device 112. In addition, the light source unit 111 may include a lens group which increases optical characteristics of projected light, a polarizing plate, or a dimmer element or the like which reduces the quantity of light emitted from the light source on a path which reaches the light modulation device 112 (none of them is illustrated in the drawing).

The light modulation device 112 includes, for example, a transmissive liquid crystal panel 112A, and forms an image on the liquid crystal panel 112A by receiving a signal from an image processing system which will be described later. In this case, the light modulation device 112 includes three pieces of liquid crystal panels 112A corresponding to three primary colors, that is, RGB, for color projection, light from the light source unit 111 is separated into three-color light of RGB, and the respective pieces of color light are incident into the relevant liquid crystal panels 112A. The respective pieces of color light, which pass through the respective liquid crystal panels 112A and are modulated, are synthesized by a synthesis optical system, such as a cross dichroic prism, and are emitted to the projection optical system 113.

Meanwhile, the light modulation device 112 is not limited to the configuration in which three pieces of transmissive liquid crystal panels 112A are used, and it is possible to use, for example, three pieces of reflective liquid crystal panels. In addition, the light modulation device 112 may be configured using a method of combining one piece of liquid crystal panel with color wheels, a method of using three Digital Mirror Devices (DMDs), a method of combining one piece of DMD with the color wheels, and the like. Here, in a case in which only one piece of liquid crystal panel 112A or a DMD is used as the light modulation device 112, a member corresponding to the synthesis optical system, such as the cross dichroic prism, is not necessary. In addition, it is possible to use a configuration, in which it is possible to modulate light emitted by the light source, without problems other than the liquid crystal panel 112A and the DMD.

The projection optical system 113 projects incident light, which is modulated by the light modulation device 112, onto the screen SC using a provided projection lens, thereby forming an image.

A projection optical system driving unit 121, which drives each motor included in the projection optical system 113 under the control of the control unit 130, and a light source driving unit 122, which drives the light source included in the light source unit 111 under the control of the control unit 130, are connected to the projection unit 110. The projection optical system driving unit 121 and the light source driving unit 122 are connected to a bus 105.

The projector 100 includes a wireless communication unit 156 (first communication unit). The wireless communication unit 156 is connected to the bus 105. The wireless communication unit 156 includes an antenna and a Radio Frequency (RF) circuit, or the like, which are not illustrated in the drawing, and communicates with the mobile terminal 10 in conformity to the wireless communication standards under the control of the control unit 130. The projector 100 and the mobile terminal 10 are connected to be able to transmit and receive various data through the wireless communication method.

The image processing system included in the projector 100 is formed centering on the control unit 130 which controls the whole projector 100 in an integrated manner, and, in addition, includes a storage unit 151, an image processing unit 125, a light modulation device driving unit 123, and an input processing unit 153. The control unit 130, the storage unit 151, the input processing unit 153, the image processing unit 125, and the light modulation device driving unit 123 are connected to the bus 105, respectively.

The control unit 130 includes a CPU, a ROM, a RAM, and the like which are not illustrated in the drawing, executes a basic control program, which is stored in the ROM using the CPU, and controls the projector 100. In addition, the control unit 130 functions as a projection control unit 131, a communication control unit 132, and a display control unit 133 (hereinafter, referred to as functional blocks), which will be described later, by executing an application program 41 which is stored in the storage unit 151.

The storage unit 151 is a non-volatile memory such as a flash memory or an EEPROM.

The storage unit 151 stores a control program, image data, and the like which are used for control of the projector 100. In addition, the storage unit 151 stores terminal identification information 1511, which is transmitted from the mobile terminal 10, of the mobile terminal 10. In addition, the storage unit 151 stores resolution information 1512, which is resolution information of the display panel 52 provided in the mobile terminal 10, the resolution information 1512 being transmitted from the mobile terminal 10. The resolution information 1512 includes information such as the number of vertical and horizontal pixels on a screen of the display panel 52 and an aspect ratio. The resolution information 1512 is information included in correspondence information for deciding the correspondence between a display area of the display panel 52 which is provided in the mobile terminal 10 and an area of a panel surface of the liquid crystal panel 112A (in other words, a display area of the screen SC). Meanwhile, the area of the panel surface of the liquid crystal panel 112A and the display area in which the projection image is displayed on the screen SC mutually have a corresponding relationship. Therefore, it is possible to say that the correspondence information is information for determining the correspondence between the display area of the display panel 52, included in the mobile terminal 10, and the display area of the screen SC.

The image processing unit 125 performs a resolution conversion process or the like of converting image data, which is input from an external image supply device or a display control unit 133, into resolution data which is suitable for the specification of the liquid crystal panel 112A of the light modulation device 112. In addition, the image processing unit 125 draws a display image, which is displayed by the light modulation device 112, in the frame memory 126, and outputs the drawn display image to the light modulation device driving unit 123. The light modulation device driving unit 123 drives the light modulation device 112 based on the display image which is input from the image processing unit 125. Therefore, an image is drawn on the liquid crystal panel 112A of the light modulation device 112, and the drawn image is projected onto the screen SC through the projection optical system 113 as the projection images.

In the main body of the projector 100, an operation panel 155, which includes various switches and indicator lamps for enabling the user to perform an operation, is disposed. The operation panel 155 is connected to the input processing unit 153. The input processing unit 153 causes the indicator lamp of the operation panel 155 to be appropriately lighted or flickered according to an operation state and a setting state of the projector 100 under the control of the control unit 130. In a case in which a switch of the operation panel 155 is operated, an operation signal corresponding to the operated switch is output from the input processing unit 153 to the control unit 130.

In addition, the projector 100 includes a remote controller (not illustrated in the drawing) which is used by the user. The remote controller includes various buttons, and transmits infrared signals corresponding to the operations of the buttons. In the main body of the projector 100, a remote controller receiver 154 is disposed which receives the infrared signals emitted from the remote controller. The remote controller receiver 154 decodes the infrared signals which are received from the remote controller, generates operation signals indicative of the content of operations performed in the remote controller, and outputs the operation signals to the control unit 130.

Subsequently, the functional blocks included in the control unit 130 will be described.

The projection control unit 131 draws an image in the frame memory 126 by controlling the image processing unit 125 based on the image data supplied from the image supply device through the I/F unit 124 and the image data generated by the display control unit 133. In addition, the projection control unit 131 draws the image, which is drawn in the frame memory 126, on the liquid crystal panel 112A of the light modulation device 112 by controlling the light modulation device driving unit 123. The image, which is drawn on the liquid crystal panel 112A of the light modulation device 112, is projected onto the screen SC through the projection optical system 113 as the projection image.

The communication control unit 132 performs the wireless communication with the mobile terminal 10 by controlling the wireless communication unit 156. In a case in which the communication control unit 132 is connected to the mobile terminal 10, the communication control unit 132 requests the mobile terminal 10 to transmit the terminal identification information of the mobile terminal 10. The mobile terminal 10 transmits the terminal identification information 33 of the mobile terminal 10 to the projector 100 at a request of the projector 100. The communication control unit 132 stores the received information in the storage unit 151 as the terminal identification information 1511. In addition, in a case in which the communication control unit 132 acquires the terminal identification information 1511 of the mobile terminal 10, the communication control unit 132 transmits a request for acquirement of the resolution information of the display panel 52 which is provided in the mobile terminal 10 to the mobile terminal 10. The mobile terminal 10 transmits the resolution information of the display panel 52 to the projector 100 at the request of the projector 100. The communication control unit 132 stores the acquired information in the storage unit 151 as the resolution information 1512.

The display control unit 133 transmits the image of an area, selected by the user, of an image which is being projected onto the screen SC (hereinafter, referred to as a projection image) to the selected mobile terminal 10.

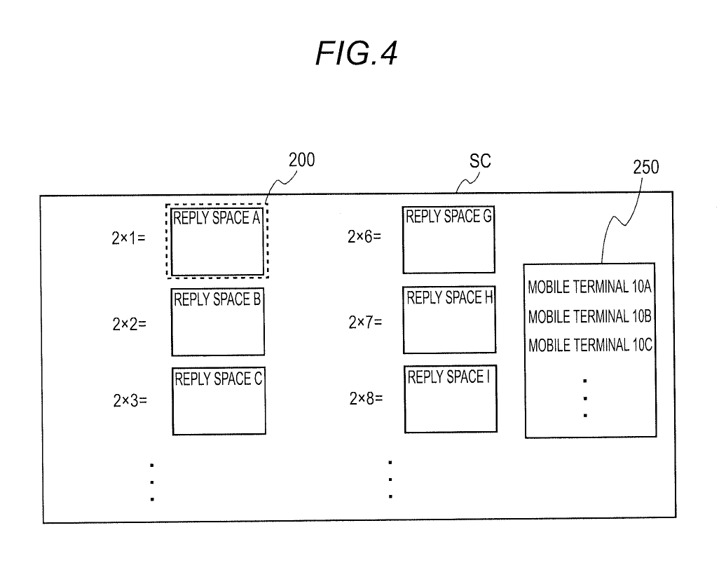

First, the display control unit 133 acquires the image data of the projection image (hereinafter, referred to as projection image data) from the image processing unit 125. In addition, the display control unit 133 receives the selection of the area of the projection image to be transmitted to the mobile terminal 10. For example, the display control unit 133 generates an operation frame 200 illustrated in FIG. 4, and projects the operation frame 200 onto the screen SC after superimposing the operation frame 200 on the projection image. It is possible to freely move the operation frame 200 on the screen SC according to the operation of the operation panel 155 or the remote controller, and it is possible to freely change the size of the operation frame 200.

The display control unit 133 changes a display location or a size of the operation frame 200 to be projected onto the screen SC according to operation input received through the operation panel 155 or the remote controller. The user moves the operation frame 200 to the area selected on the projection image according to the operation of the operation panel 155 or the remote controller, and presses an enter button of the operation panel 155 or the remote controller. In a case in which the display control unit 133 receives the operation input of the enter button, the display control unit 133 determines the area of the projection image, which is displayed in the operation frame 200, as a selected area (hereinafter, referred to as selection area).

In addition, the display control unit 133 receives the input of selection of the mobile terminal 10 to which the image selected through the operation of the operation frame 200 will be transmitted. For example, the display control unit 133 displays a display area 250, in which the identification information of the communicable mobile terminal 10 is displayed, on the operation panel 155 or the screen SC, and receives the operation input of the operation panel 155 and the remote controller from the user.

In a case in which the display control unit 133 receives input of the selection of the selection area which is transmitted to the mobile terminal 10 and selection of the mobile terminal 10 to which the image of the selection area is transmitted, the display control unit 133 extracts image data corresponding to the selection area (hereinafter, referred to as partial image data) from the image data of the projection image. The partial image data may be image data corresponding to at least a part of the projection image data or may be the whole projection image data. In addition, the display control unit 133 stores location information indicative of a location in the projection image data, from which the partial image data is cut, in the storage unit 151. The location information is information included in the correspondence information for deciding the correspondence between the display area of the display panel 52 which is provided in the mobile terminal 10 and the area of the panel surface of the liquid crystal panel 112A.

In addition, in a case in which the plurality of mobile terminals 10A, 10B, and 10C are connected to the projector 100, the location information may be set for the respective mobile terminals 10A, 10B, and 10C. In addition, for example, the same location information may be set to the plurality of mobile terminals 10 including the mobile terminal 10A and the mobile terminal 10B. In this case, the same partial image data is displayed on the display panels 52 of the mobile terminal 10A and the mobile terminal 10B.

Subsequently, the display control unit 133 performs conversion on a size of the extracted partial image data. The display control unit 133 acquires the resolution information of the display panel 52, which is provided in the mobile terminal 10 that is the transmission target of the first partial image data, from the storage unit 151. The display control unit 133 performs size conversion on the partial image data into a size that is suitable for the resolution of the display panel 52 which is provided in the mobile terminal 10 according to the acquired resolution information 1512. The display control unit 133 transmits the partial image data, on which the size conversion is performed, to the mobile terminal 10.

Meanwhile, in the first embodiment, the display control unit 133 generates the partial image data which is acquired by cutting a part of the projection image data, converts the size of the generated partial image data into the size which is suitable for the resolution of the display panel 52 which is provided in the mobile terminal 10, and transmits the partial image data acquired through the size conversion to the mobile terminal 10. In addition, the display control unit 133 may generate frame image data which indicates the frame of the partial image data and may transmit the generated frame image data to the mobile terminal 10. That is, the frame image data is data which does not include the projection image and expresses the frame of the image.

In a case in which the display control unit 21 of the mobile terminal 10 receives the partial image data from the projector 100, the display control unit 21 outputs the received partial image data to the display unit 51 and displays the partial image data on the display panel 52.

If a contact operation is performed on the display panel 52 by the user in a state in which the partial image data is displayed on the display panel 52, the operation detection unit 55 outputs coordinate information indicative of an operation location to the control unit 20. In a case in which the coordinate information is input from the operation detection unit 55, the display control unit 21 detects the unique operation of the touch panel based on the input coordinate information. For example, the display control unit 21 detects an operation, such as pinch-in or pinch-out, performed on the display panel 52.

In a case in which the display control unit 21 detects the unique operation of the touch panel, such as pinch-in or pinch-out, the display control unit 21 generates control data, which includes the touch operation information indicative of the detected operation and coordinate information input from the operation detection unit 55, and passes the control data to the communication control unit 22. In addition, in a case in which it is difficult to detect the unique operation of the touch panel, the display control unit 21 passes control data, which includes the coordinate information input from the operation detection unit 55, to the communication control unit 22. The communication control unit 22 transmits the control data, which is passed from the display control unit 21, to the projector 100 through the wireless communication unit 40.

The projector 100 receives the control data, which is transmitted from the mobile terminal 10, by the wireless communication unit 156. The received control data is passed to the display control unit 133 under the control of the communication control unit 132. The display control unit 133 extracts the coordinate information from the acquired control data and reads the resolution information 1512 from the storage unit 151. The display control unit 133 generates the image data (hereinafter, referred to as operation image data) based on the coordinate information and the resolution information 1512.

Since the coordinate information is the coordinate information of the display panel 52 (touch screen 53), the display control unit 133 generates the operation image data by the resolution of the display panel 52 with reference to the resolution information 1512. The operation image data is image data indicative of a traveling locus of a user finger, an electronic pen, or the like which performs the contact operation on the display surface of the display panel 52, and includes, for example, a letter, a figure, and the like. In a case in which the operation image data is generated, the display control unit 133 reads location information from the storage unit 151. The location information is information indicative of a location in the projection image data from which the partial image data is cut. The display control unit 133 passes the operation image data to the image processing unit 125 together with the location information.

In addition, in a case in which the control data includes the touch operation information, the display control unit 133 outputs an instruction to enlarge or reduce the projection image data to the image processing unit 125 according to the touch operation information.

The image processing unit 125 performs size conversion on the operation image data, which is acquired from the display control unit 133, into a size which is suitable for the resolution of the liquid crystal panel 112A. In addition, the image processing unit 125 superimposes the operation image data, on which the size conversion is performed, on the projection image data according to the location information which is acquired from the display control unit 133. The image processing unit 125 performs drawing in the frame memory 126 such that the operation image data is superimposed on the location of the projection image data from which the partial image data is cut.

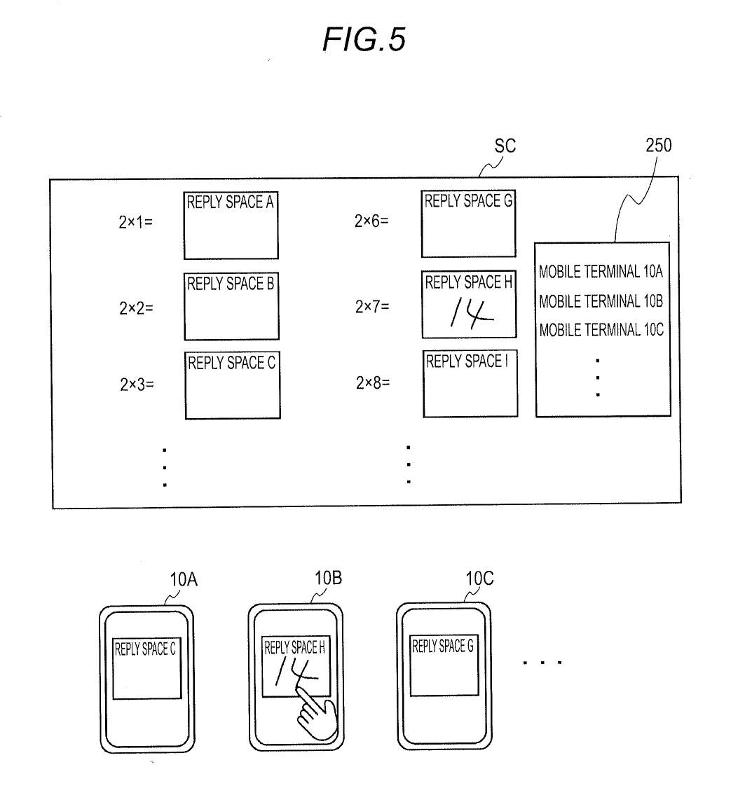

In addition, in a case in which the instruction to enlarge or reduce the projection image data is input from the display control unit 133, the image processing unit 125 performs a process of enlarging or reducing the image size of the projection image data which is drawn to the frame memory 126 according to the instruction. Thereafter, the image data drawn in the frame memory 126 is drawn on the liquid crystal panel 112A of the light modulation device 112 under the control of the projection control unit 131, and the drawn image is projected onto the screen SC as the projection image through the projection optical system 113. Therefore, for example, as illustrated in FIG. 5, second partial image data which is transmitted from the mobile terminal 10B is displayed in a projection image data reply space H.

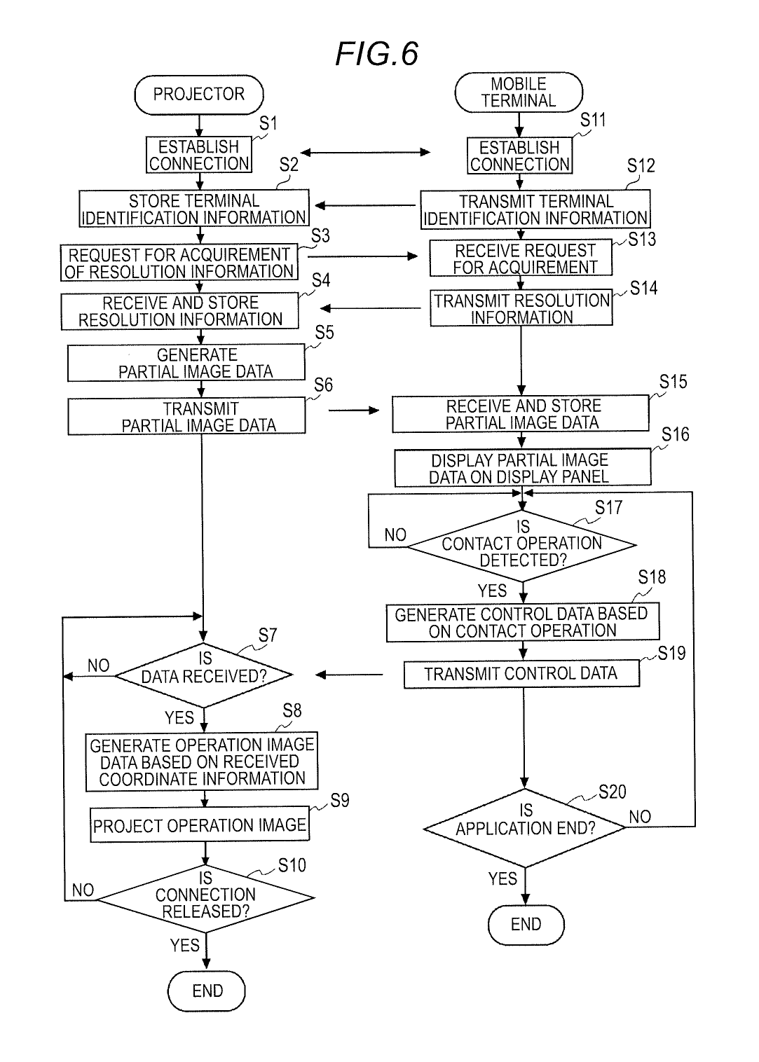

Subsequently, a process procedure of the first embodiment will be described with reference to a flowchart illustrated in FIG. 6.

The user, first, operates the mobile terminal 10 and starts the application program 31 in order to project the image which is stored in the storage unit 30. In a case in which the operation performed by the user is received, the control unit 20 reads the application program 31 from the storage unit 30 and executes the application program 31. In a case in which the application program 31 starts, the mobile terminal 10 and the projector 100 perform wireless communication to establish mutual communication.

The connection between the mobile terminal 10 and the projector 100 may be configured to be connected, for example, by specifying the projector 100 which is designated by the user in a case in which the application program 31 starts. In addition, the connection between the mobile terminal 10 and the projector 100 may be configured such that connection is performed by automatically detecting the projector 100 which is capable of transmitting and receiving a wireless signal. As above, first, the connection between the mobile terminal 10 and the projector 100 is established based on the operation performed in the mobile terminal 10 of the user (step S1 and S11).

Here, the communication control unit 22 of the mobile terminal 10 transmits the terminal identification information, which specifies the individual of the mobile terminal 10, to the projector 100 by controlling the wireless communication unit 40 (step S12). The control unit 130 of the projector 100 receives information, which is transmitted from the mobile terminal 10, and stores the received information in the storage unit 151 as the terminal identification information 1511 (step S2).

In a case in which the connection with the mobile terminal 10 is established and the terminal identification information 1511 is received from the mobile terminal 10, the projector 100 transmits a request for acquirement of the resolution information of the mobile terminal 10 to the mobile terminal 10 (step S3). The resolution information includes information such as the number of vertical and horizontal pixels of the screen of the display panel 52 and an aspect ratio. In a case in which the communication control unit 22 of the mobile terminal 10 receives the request for acquirement from the projector 100 (step S13), the communication control unit 22 transmits the resolution information to the projector 100 at the received request of acquirement (step S14). The communication control unit 132 of the projector 100 stores the information which is received by the wireless communication unit 156 in the storage unit 151 as the resolution information 1512 (step S4).

Subsequently, the display control unit 133 of the projector 100 generates the partial image data which is transmitted to the mobile terminal 10 (step S5). For example, the display control unit 133 generates an image which indicates the operation frame 200 illustrated in FIG. 4, superimposes the image on the projection image, and projects the superimposed image onto the screen SC. In a case in which an area of the projection image which is transmitted to the mobile terminal 10 is selected through the operation performed on the operation panel 155 or the remote controller by the user, the display control unit 133 extracts the selected area from the image data of the projection image, and generates the partial image data.

In addition, the display control unit 133 converts the size of the partial image data into a size, which is suitable for the resolution of the display panel 52 which is provided in the mobile terminal 10, according to the resolution information which is acquired from the mobile terminal 10. The display control unit 133 transmits the partial image data, which is acquired through the size conversion, to the mobile terminal 10 (step S6). The mobile terminal 10 receives the partial image data, which is transmitted from the projector 100, by the wireless communication unit 40 (step S15). The mobile terminal 10 displays the received partial image data on the display panel 52 under the control of the display control unit 21 (step S16).

In a case in which the partial image data is displayed on the display panel 52, the mobile terminal 10 detects the contact operation, performed on the display panel 52 by the user, by the operation detection unit 55. The operation detection unit 55 detects the contact operation performed on the display panel 52 by inputting the location signal indicative of the operation location from the touch screen 53 (step S17). In a case in which the location signal is input (step S17/YES), the operation detection unit 55 generates coordinate information according to the location signal, and outputs the coordinate information to the control unit 20. In a case in which the coordinate information is input from the operation detection unit 55, the display control unit 21 detects an operation which is unique to the operation of the touch panel based on the input coordinate information.

In a case in which the operation, such as pinch-in or pinch-out, is detected, the display control unit 21 generates the touch operation information indicative of the detected operation, generates control data, which includes the generated touch operation information and coordinate information that is input from the operation detection unit 55 (step S18), and passes the control data to the communication control unit 22. In addition, in a case in which the operation, such as pinch-in or pinch-out, is not detected, the display control unit 21 generates control data which includes the coordinate information that is input from the operation detection unit 55 (step S18), and passes the control data to the communication control unit 22.

The communication control unit 22 transmits control data, which is passed from the display control unit 21, to the projector 100 through the wireless communication unit 40 (step S19). In a case in which the transmission of the control data ends, the control unit 20 determines whether or not an end operation of ending the application program 31 is input (step S20). In a case in which the end operation is input (step S20/YES), the control unit 20 ends the process flow. In addition, in a case in which the end operation is not input (step S20/NO), the control unit 20 returns to step S17, and detects the contact operation again (step S17).

The projector 100 receives control data, which is transmitted from the mobile terminal 10, by the wireless communication unit 156 (step S7). The control data, which is received by the wireless communication unit 156, is passed to the display control unit 133. The display control unit 133 extracts the coordinate information from the acquired control data, and generates the operation image data based on the extracted coordinate information (step S8).

In a case in which the operation image data is generated, the display control unit 133 reads the location information from the storage unit 151. The display control unit 133 passes the operation image data to the image processing unit 125 together with the location information. In addition, in a case in which the control data includes the touch operation information, the display control unit 133 outputs the instruction to enlarge or reduce the projection image data to the image processing unit 125 according to the touch operation information.

The image processing unit 125 converts the size of the operation image data, which is acquired from the display control unit 133, into a size which is suitable for the resolution of the liquid crystal panel 112A. In addition, the image processing unit 125 superimposes the operation image data, on which the size conversion is performed, on the projection image data according to the location information acquired from the display control unit 133. The image processing unit 125 performs drawing in the frame memory 126 such that the operation image data is superimposed on a location in which the partial image data in the projection image data is cut.

In addition, in a case in which the instruction to enlarge or reduce the projection image data is input from the display control unit 133, the image processing unit 125 performs a process of enlarging or reducing the image size of the projection image data, which is drawn in the frame memory 126, according to the instruction. Thereafter, the image data drawn in the frame memory 126 is drawn on the liquid crystal panel 112A of the light modulation device 112 under the control of the projection control unit 131, and the drawn image is projected onto the screen SC as the projection image through the projection optical system 113 (step S9).

Subsequently, the control unit 130 of the projector 100 determines whether or not the connection with the mobile terminal 10 is released (step S10). In a case in which it is determined that the connection with the mobile terminal 10 is released (step S10/YES), the control unit 130 ends the process flow. In addition, in a case in which it is determined that the connection with the mobile terminal 10 is not released (step S10/NO), the control unit 130 returns to step S7, and waits for the reception of the data from the mobile terminal 10 (step S7).

As described above, in the first embodiment, in a case in which a contact operation is performed on the display panel 52 of the mobile terminal 10, the mobile terminal 10 generates coordinate information indicative of the operation location of the contact operation and transmits the coordinate information to the projector 100. The projector 100 generates an image based on the coordinate information transmitted from the mobile terminal 10, and projects the image onto the screen SC. Since the mobile terminal 10 may generate the coordinate information indicative of the operation location of the contact operation and may transmit the coordinate information to the projector 100, it is possible to reduce the processing loads of the mobile terminal 10.

### Second Embodiment

In the above-described first embodiment, the mobile terminal 10 transmits the coordinate information indicative of the coordinates of the touch screen 53 to the projector 100 without change. Furthermore, the projector 100 generates the operation image based on the coordinate information, and converts the operation image into data of a resolution which is suitable for the specification of the liquid crystal panel 112A. In a second embodiment, the mobile terminal 10 generates coordinate information according to the resolution of the liquid crystal panel 112A of the projector 100 and transmits the coordinate information to the projector 100.

The details of the second embodiment will be described below. Also, in the description below, the same reference numerals are attached to parts which are the same as the already described parts, and the description thereof will not be repeated.

In a case in which the partial image data is generated, the display control unit 133 of the projector 100 transmits the partial image data to the mobile terminal 10 without performing size conversion on the generated partial image data into a size which is suitable for the resolution of the display panel 52. Specifically, the display control unit 133 adds information indicative of the starting point location of the partial image data to the partial image data, and transmits the resulting information to the mobile terminal 10.

Meanwhile, the display control unit 133 may generate frame image data, which indicates the frame of the partial image data, in addition to the partial image data, and may transmit the generated frame image data to the mobile terminal 10. That is, the frame image data may be data which does not include the projection image and in which it is possible for the mobile terminal 10 to recognize the size of the partial image data (the number of vertical and horizontal pixels and the aspect ratio of an image).

In a case in which the partial image data is received from the projector 100, the display control unit 21 of the mobile terminal 10 stores the received partial image data in the storage unit 30. In addition, the display control unit generates a coordinate conversion table, in which coordinates on the touch screen 53 is converted into coordinates on the partial image data, based on the partial image data which is stored in the storage unit 30. First, the display control unit 21 acquires the number of vertical and horizontal pixels in the partial image data from the received partial image data.

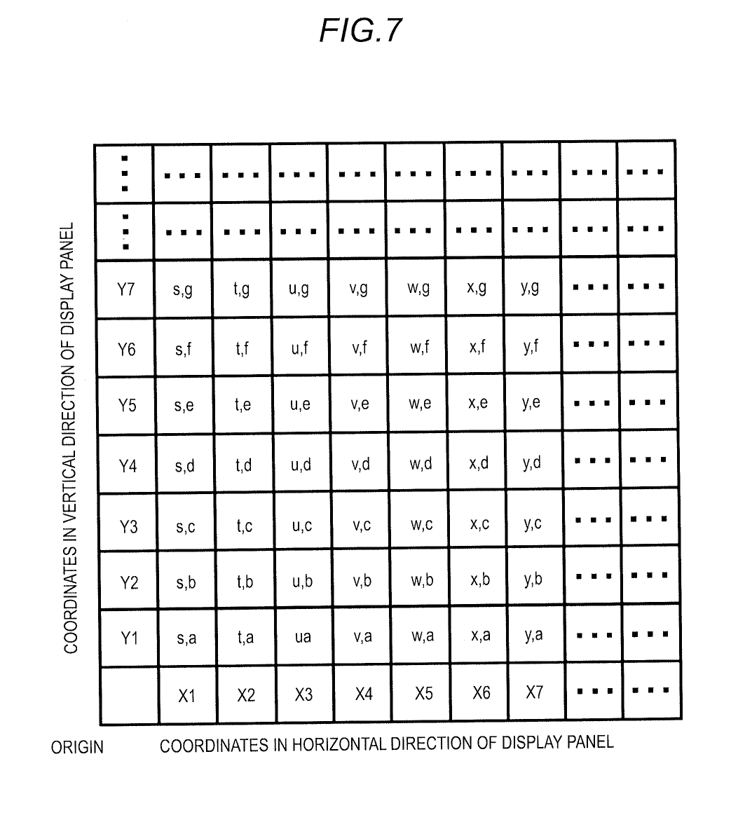

Subsequently, the display control unit 21 generates the coordinate conversion table in which the coordinates on the touch screen 53 is converted into the coordinates on the partial image data based on the number of vertical and horizontal pixels in the acquired partial image data, a starting point location, and the number of vertical and horizontal pixels of the display screen of the display panel 52. FIG. 7 illustrates an example of the coordinate conversion table. The coordinate conversion table illustrated in FIG. 7 corresponds to coordinates (Y1, Y2, Y3, . . . ) in the vertical direction and coordinates (X1, X2, X3, . . . ) in the horizontal direction of the display panel 52. Registration is performed in such a way that the coordinates in the vertical direction is associated with the coordinates in the horizontal direction of the partial image data.

In addition, in a case in which the coordinate information, which indicates the coordinates on the touch screen 53, is input from the operation detection unit 55, the display control unit 21 of the mobile terminal 10 converts the coordinates on the touch screen 53, which is indicated by the input coordinate information, into the coordinates on the partial image data with reference to the coordinate conversion table. The display control unit 21 generates control data, which includes the coordinate information acquired through the conversion, and passes the control data to the communication control unit 22. The communication control unit 22 transmits the control data, which is passed from the display control unit 21, to the projector 100 by controlling the wireless communication unit 40.

In a case in which the coordinate information is acquired from the mobile terminal 10, the display control unit 133 of the projector 100 generates the operation image data based on the acquired coordinate information. Meanwhile, the operation image data, which is generated here, is image data based on the coordinates on the partial image data which is transmitted from the projector 100 to the mobile terminal 10. In a case in which the operation image data is generated, the display control unit 133 passes the generated operation image data to the image processing unit 125, together with the location information.

The image processing unit 125 superimposes the operation image data on the projection image data according to the location information acquired from the display control unit 133. The image processing unit 125 performs drawing on the frame memory 126 such that the operation image data is superimposed on the location in which the partial image data of the projection image data is cut. Thereafter, the image data drawn in the frame memory 126 is drawn on the liquid crystal panel 112A of the light modulation device 112 under the control of the projection control unit 131, and the drawn image is projected onto the screen SC as the projection image through the projection optical system 113.

In the second embodiment, in a case in which a contact operation is performed on the display panel 52 of the mobile terminal 10, the mobile terminal 10 generates the coordinate information, which indicates the operation location of the contact operation, and transmits the coordinate information to the projector 100. Since the mobile terminal 10 may generate the coordinate information, which indicates the operation location of the contact operation and may transmit the coordinate information to the projector 100, it is possible to reducing the processing loads of the input device.

As described above, the display system 1 includes the mobile terminal 10 and the projector 100. The mobile terminal 10 includes the operation detection unit 55 which detects the operation performed on the touch screen 53 and generates the coordinate information indicative of the operation location on the touch screen 53, and a wireless communication unit 40 which transmits the coordinate information to the projector 100. The projector 100 includes the wireless communication unit 156 which receives the coordinate information and the display control unit 133 which generates an image based on the received coordinate information and displays the image on the screen SC. Accordingly, it is possible to reduce the processing loads of the mobile terminal 10.

In the display system 1, the projector 100 includes the storage unit 30 which stores correspondence information for deciding the correspondence between the display area of the display panel 52 which is provided in the mobile terminal 10 and the area of the panel surface of the liquid crystal panel 112A. The display control unit 133 generates an image based on the coordinate information according to the correspondence information, displays the image on the panel surface of the liquid crystal panel 112A, and projects the image onto the screen SC. Accordingly, in the projector 100, it is possible to generate the image based on the coordinate information transmitted from the mobile terminal 10 according to the correspondence information and to display the image on the screen SC.

In the display system 1, the projector 100 includes the wireless communication unit 156 which transmits the image data to the mobile terminal 10. In addition, the mobile terminal 10 includes the wireless communication unit 40 which receives the image data, and the display unit 51 which displays the image based on the received image data on the display panel 52 which is superimposedly disposed on the touch screen 53. Accordingly, in a case in which an operation is performed on the display panel 52 on which the image is displayed, it is possible to perform the operation on the touch screen 53, and thus it is possible to perform intuitive operation in the mobile terminal 10.

In the display system 1, the projector 100 transmits at least a part of image data of the image, which is displayed on the screen SC, to the mobile terminal 10 as the image data. Accordingly, it is possible to display image data corresponding to a part of the image, which is displayed on the screen SC, in the mobile terminal 10.

In the display system 1, the projector 100 transmits image data corresponding to a partial image selected from the image, which is displayed on the screen SC, to the mobile terminal 10. Accordingly, it is possible to display the partial image selected from the image, which is displayed on the screen SC, in the mobile terminal 10.

In the display system 1, the projector 100 transmits image data, which indicates the area of the panel surface of the liquid crystal panel 112A that displays the image based on the coordinate information, to the mobile terminal 10. Accordingly, it is possible to display the image data, which indicates the area of the panel surface of the liquid crystal panel 112A that displays the image, in the mobile terminal 10.

In the display system 1, in a case in which the coordinate information is the operation information for enlarging or reducing the image, the display control unit 133 enlarges or reduces the image, which is displayed on the screen SC, according to the operation information. Accordingly, it is possible to enlarge or reduce the image, which is displayed on the screen SC, according to the operation from the mobile terminal 10.

### Third Embodiment

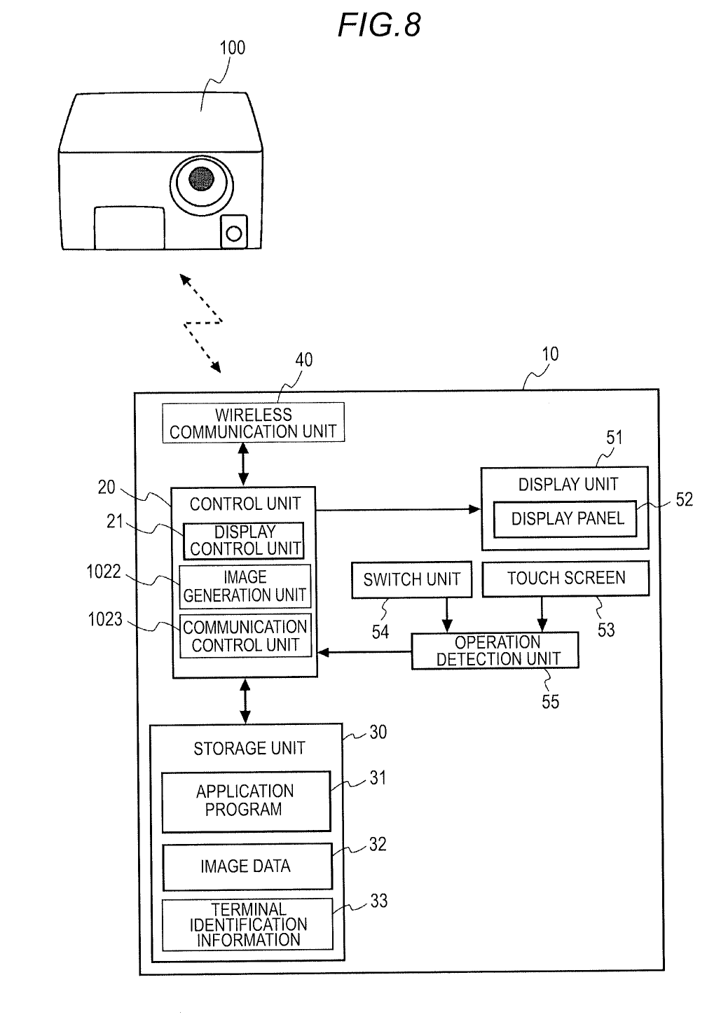

FIG. 8 illustrates an example of a functional configuration of a mobile terminal 10 according to a third embodiment.

In the third embodiment, a control unit 20 functions as a display control unit 21, an image generation unit 1022, and a communication control unit 1023 by executing an application program 31 which is stored in a storage unit 30.

The image generation unit 1022 inputs coordinate information from an operation detection unit 55. In a case in which the coordinate information is input from the operation detection unit 55, the image generation unit 1022 generates an image based on the input coordinate information. Furthermore, the image generation unit 1022 generates image data, in which the generated image data is superimposed on the image data transmitted from a projector 100, and passes the generated image data to the communication control unit 1023. The communication control unit 1023 transmits the image data, which is passed from the image generation unit 1022, to the mobile terminal 10 through a wireless communication unit 40. Meanwhile, the details of the above processes will be described later.

The communication control unit 1023 performs wireless communication with the projector 100 by controlling the wireless communication unit 40. After the communication control unit 1023 is connected to the projector 100, the communication control unit 1023 transmits terminal identification information 33, which is read from a storage unit 151, and the information which is passed from the control unit 20, to the projector 100 through the wireless communication unit 40. In addition, the communication control unit 1023 stores data, such as the image data received from the projector 100, in the storage unit 30.

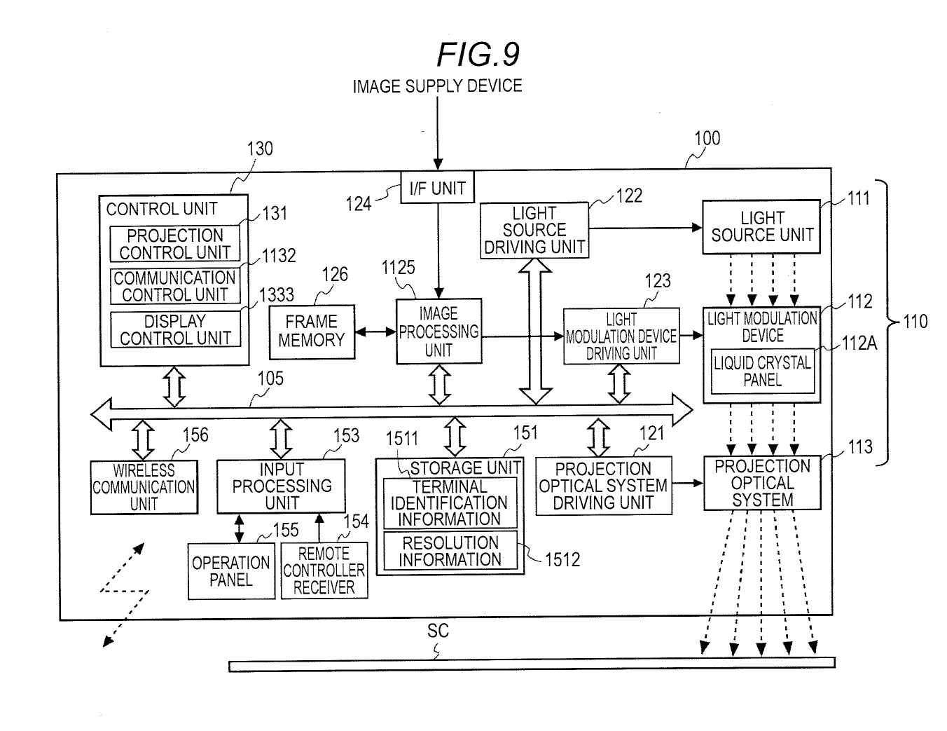

Subsequently, the configuration of the projector 100 will be described. FIG. 9 illustrates an example of a functional configuration of the projector 100.

An image processing system included in the projector 100 is formed centering on a control unit 130, which controls the whole projector 100 in an integrated manner, and includes a storage unit 151, an image processing unit 1125, a light modulation device driving unit 123, and an input processing unit 153. Each of the control unit 130, the storage unit 151, the input processing unit 153, the image processing unit 1125, and the light modulation device driving unit 123 is connected to a bus 105.

In addition, in the third embodiment, the control unit 130 functions as a projection control unit 131, a communication control unit 1132, and a display control unit 1133 (hereinafter, referred to as functional blocks), which will be described later, by executing an application program 41 which is stored in the storage unit 151.

The image processing unit 1125 performs a resolution conversion process or the like of converting the image data, which is input from an external image supply device or the display control unit 1133, into data having a resolution which is suitable for the specification of the liquid crystal panel 112A of the light modulation device 112. In addition, the image processing unit 1125 draws a display image, which is displayed by a light modulation device 112, in a frame memory 126, and outputs the drawn display image to the light modulation device driving unit 123. The light modulation device driving unit 123 drives the light modulation device 112 based on the display image which is input from the image processing unit 1125. Therefore, the image is drawn on the liquid crystal panel 112A of the light modulation device 112, and the drawn image is projected onto the screen SC as the projection image through the projection optical system 113.

Subsequently, functional blocks which are included in the control unit 130 will be described.

The projection control unit 131 draws an image in the frame memory 126 by controlling the image processing unit 1125 based on the image data which is supplied from the image supply device through an I/F unit 124 and the image data which is generated by the display control unit 1133. In addition, the projection control unit 131 draws the image, which is drawn in the frame memory 126, on the liquid crystal panel 112A of the light modulation device 112 by controlling the light modulation device driving unit 123. The image, which is drawn on the liquid crystal panel 112A of the light modulation device 112, is projected onto the screen SC as the projection image through the projection optical system 113.

The communication control unit 1132 performs the wireless communication with the mobile terminal 10 by controlling a wireless communication unit 156. In a case in which the communication control unit 1132 is connected to the mobile terminal 10, the communication control unit 1132 requests the mobile terminal 10 to transmit the terminal identification information 33 of the mobile terminal 10. The mobile terminal 10 transmits the terminal identification information 33 of the mobile terminal 10 to the projector 100 at the request of the projector 100. The communication control unit 1132 stores the received information in the storage unit 151 as terminal identification information 1511.

In addition, in a case in which the communication control unit 1132 acquires the terminal identification information 1511 of the mobile terminal 10, the communication control unit 1132 transmits a request for acquirement of the resolution information of the display panel 52 provided in the mobile terminal 10 to the mobile terminal 10. The mobile terminal 10 transmits the resolution information of the display panel 52 to the projector 100 at the request of the projector 100. The communication control unit 1132 stores the acquired information in the storage unit 151 as resolution information 1512.

The display control unit 1133 transmits an image of an area, which is selected by the user, of the image which is being projected (hereinafter, referred to as a projection image) onto the screen SC to the selected mobile terminal 10.

First, the display control unit 1133 acquires the image data of the projection image (hereinafter, referred to as projection image data) from the image processing unit 1125. In addition, the display control unit 1133 receives the selection of the area of the projection image which is transmitted to the mobile terminal 10. For example, the display control unit 1133 generates the operation frame 200 illustrated in FIG. 4, superimposes the operation frame 200 on the projection image, and projects the superimposed image onto the screen SC. It is possible to freely move the operation frame 200 on the screen SC through the operation of the operation panel 155 or the remote controller, and it is possible to freely change the size of the operation frame 200.

The display control unit 1133 changes the display location and the size of the operation frame 200, which is projected onto the screen SC, according to the operation input which is received through the operation panel 155 or the remote controller. The user moves the operation frame 200 to the area, which is selected on the projection image, through the operation of the operation panel 155 or the remote controller, and presses the enter button of the operation panel 155 or the remote controller. In a case in which the operation input of the enter button is received, the display control unit 1133 determines the area of the projection image, which is displayed in the operation frame 200, to be a selected area (hereinafter, referred to as a selection area). Meanwhile, the selection area may be an area which includes the whole projection image or may be an area of a part of the projection image.

In addition, the display control unit 1133 receives the input of selection of the mobile terminal 10 to which the image selected through the operation of the operation frame 200 is transmitted. For example, the display control unit 1133 displays a display area 250, which displays the identification information of the communicable mobile terminal 10, on the operation panel 155 or the screen SC, and receives the operation input of the operation panel 155 or the remote controller from the user.

In a case in which the display control unit 1133 receives the input of selection of the selection area which is transmitted to the mobile terminal 10 and the selection of the mobile terminal 10 to which the image of the selection area is transmitted, the display control unit 1133 extracts the image data corresponding to the selection area (hereinafter, referred to as first partial image data) from the image data of the projection image. Meanwhile, the display control unit 1133 stores location information, which indicates the location of the first partial image data of the projection image data, in the storage unit 151.

In addition, in a case in which a plurality of mobile terminals 10A, 10B, and 10C are connected to the projector 100, the location information may be set for each of the mobile terminals 10A, 10B, and 10C. In addition, for example, the same location information may be set for the plurality of mobile terminals 10 including the mobile terminal 10A and the mobile terminal 10B. In this case, the same first partial image data is displayed on the display panels 52 of the mobile terminal 10A and the mobile terminal 10B.

Subsequently, the display control unit 1133 performs conversion on a size of the extracted first partial image data. The display control unit 1133 acquires the resolution information of the display panel 52, which is provided in the mobile terminal 10 that is the transmission target of the first partial image data, from the storage unit 151. The display control unit 1133 performs size conversion on the first partial image data into a size that is suitable for the resolution of the display panel 52 which is provided in the mobile terminal 10 according to the acquired resolution information 1512. The display control unit 1133 transmits the first partial image data, on which the size conversion is performed, to the mobile terminal 10.

In a case in which the first partial image data is received from the projector 100, the display control unit 21 of the mobile terminal 10 outputs the received first partial image data to the display unit 51, and displays the first partial image data on the display panel 52.

In a case in which a contact operation is performed on the display panel 52 by the user in a state in which the first partial image data is displayed on the display panel 52, the operation detection unit 55 outputs coordinate information, which indicates the operation location, to the control unit 20. In a case in which the image generation unit 1022 receives the input of the coordinate information from the operation detection unit 55, the image generation unit 1022 generates image data (hereinafter, referred to as an operation image) based on the input coordinate information. The operation image data is image data indicative of a traveling locus of a user finger, an electronic pen, or the like which performs the contact operation on the display surface of the display panel 52, and includes, for example, a letter, a figure, and the like.

In a case in which the operation image data is generated, the image generation unit 1022 generates second partial image data (operation data) in which the generated operation image data is superimposed on the first partial image data. The image generation unit 1022 passes the generated second partial image data to the communication control unit 1023. The communication control unit 1023 transmits the second partial image data, which is passed from the image generation unit 1022, to the projector 100 through the wireless communication unit 40.

The projector 100 receives the second partial image data, which is transmitted from the mobile terminal 10, using the wireless communication unit 156. The received second partial image data is passed to the display control unit 1133 under the control of the communication control unit 1132. In a case in which the second partial image data is acquired, the display control unit 1133 reads the location information from the storage unit 151. The location information is information indicative of a location in the projection image data from which the first partial image data is cut. The display control unit 1133 passes the second partial image data to the image processing unit 1125, together with the location information.

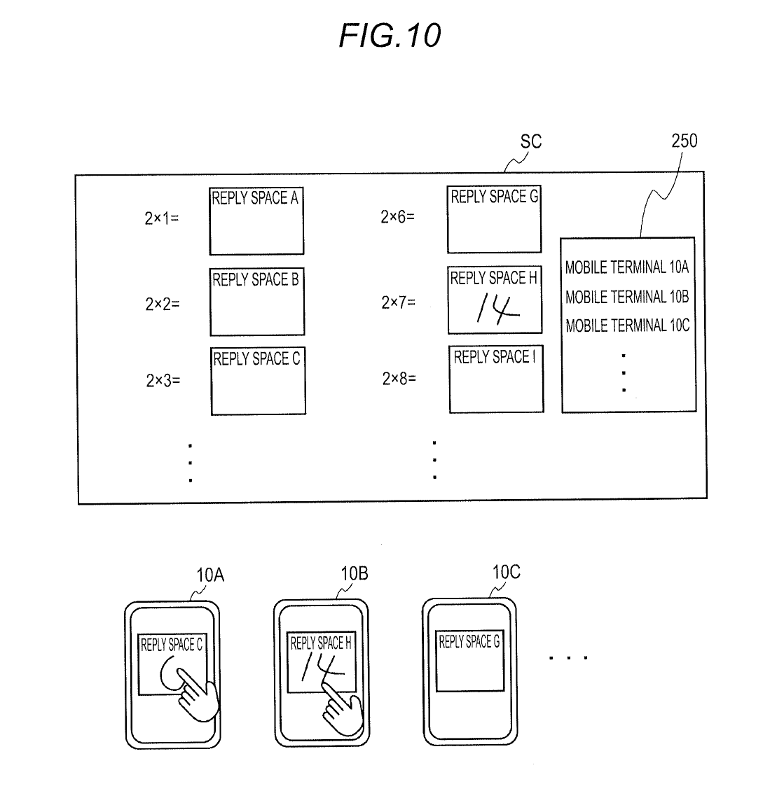

Image processing unit 1125 converts the size of the second partial image data, which is acquired from the display control unit 1133, into a size which is suitable for the resolution of the liquid crystal panel 112A. In addition, the image processing unit 1125 superimposes the second partial image data, on which the size conversion is performed, on the projection image data according to the location information which is acquired from the display control unit 1133. The image processing unit 1125 performs drawing in the frame memory 126 such that the second partial image data is superimposed on the location in the projection image data from which the first partial image data is cut. Thereafter, the image data drawn in the frame memory 126 is drawn on the liquid crystal panel 112A of the light modulation device 112 under the control of the projection control unit 131, and the drawn image is projected onto the screen SC as the projection image through the projection optical system 113. Therefore, for example, as illustrated in FIG. 10, the second partial image data, which is transmitted from the mobile terminal 10B, is displayed in a projection image data reply space H.

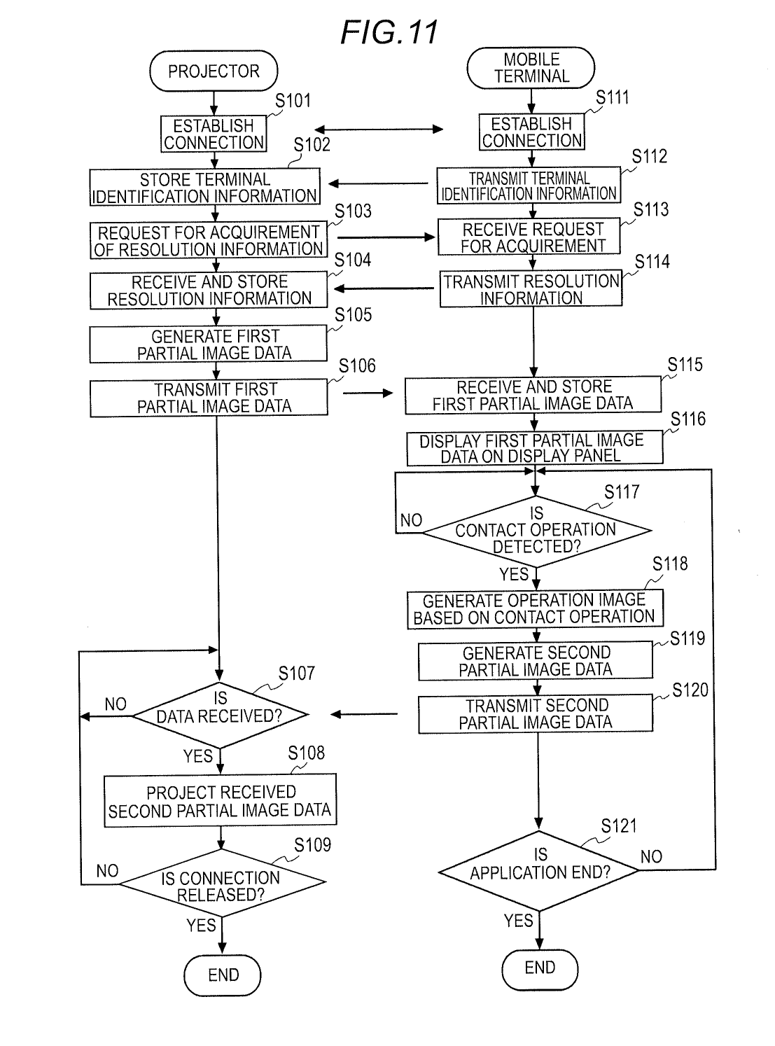

Subsequently, a process procedure of the third embodiment will be described with reference to a flowchart illustrated in FIG. 11.

The user, first, operates the mobile terminal 10 and starts the application program 31 in order to project the image which is stored in the storage unit 30. In a case in which the operation performed by the user is received, the control unit 20 reads the application program 31 from the storage unit 30 and extracts the application program 31. In a case in which the application program 31 starts, the mobile terminal 10 and the projector 100 perform wireless communication to establish mutual communication. The connection between the mobile terminal 10 and the projector 100 may be configured to be connected by, for example, specifying the projector 100 which is designated by the user in a case in which the application program 31 starts.

In addition, the connection between the mobile terminal 10 and the projector 100 may be configured such that connection is performed by automatically detecting the projector 100 which is capable of transmitting and receiving a wireless signal. As above, first, the connection between the mobile terminal 10 and the projector 100 is established based on the operation performed in the mobile terminal 10 of the user (step S101 and S111). Here, the communication control unit 1023 of the mobile terminal 10 transmits terminal identification information 33, which specifies the individual of the mobile terminal 10, to the projector 100 by controlling the wireless communication unit 40 (step S112). The control unit 130 of the projector 100 receives information, which is transmitted from the mobile terminal 10, and stores the received information in the storage unit 151 as the terminal identification information 1511 (step S102).

In a case in which the connection with the mobile terminal 10 is established and the terminal identification information 1511 is received from the mobile terminal 10, the projector 100 transmits a request for acquirement of the resolution information of the mobile terminal 10 to the mobile terminal (step S103). The resolution information includes information such as the number of vertical and horizontal pixels of the screen of the display panel 52 and an aspect ratio. In a case in which the communication control unit 1023 of the mobile terminal 10 receives the request for acquirement from the projector 100 (step S113), the communication control unit 1023 transmits the resolution information to the projector 100 at the received request of acquirement (step S114). The communication control unit 1132 of the projector 100 stores the information which is received by the wireless communication unit 156 in the storage unit 151 as the resolution information 1512 (step S104).

Subsequently, the display control unit 1133 of the projector 100 generates the first partial image data which is transmitted to the mobile terminal 10 (step S105). For example, the display control unit 1133 generates an image which indicates the operation frame 200 illustrated in FIG. 4, superimposes the image on the projection image, and projects the superimposed image onto the screen SC. In a case in which an area of the projection image which is transmitted to the mobile terminal 10 is selected through the operation performed on the operation panel 155 or the remote controller by the user, the display control unit 1133 extracts the selected area from the image data of the projection image, and generates the first partial image data (step S105).

In addition, the display control unit 1133 converts the size of the first partial image data into a size, which is suitable for the resolution of the display panel 52 which is provided in the mobile terminal 10, according to the resolution information 1512 which is acquired from the mobile terminal 10. The display control unit 1133 transmits the partial image data, which is acquired through the size conversion, to the mobile terminal 10 (step S106). The mobile terminal 10 receives the first partial image data, which is transmitted from the projector 100, by the wireless communication unit 40, and stored in the storage unit 30 (step S115). The mobile terminal 10 displays the received first partial image data on the display panel 52 under the control of the display control unit 21 (step S116).

In a case in which the first partial image data is displayed on the display panel 52, the mobile terminal 10 detects the contact operation, performed on the display panel 52 by the user, by the operation detection unit 55. The operation detection unit 55 detects the contact operation performed on the display panel 52 by inputting the location signal indicative of the operation location from the touch screen 53 (step S117). In a case in which the location signal is input from the touch screen 53 (step S117/YES), the operation detection unit 55 generates coordinate information according to the location signal, and outputs the coordinate information to the control unit 20. In a case in which the coordinate information, which is output from the operation detection unit 55, is input, the image generation unit 1022 of the mobile terminal 10 generates the operation image data based on the input coordinate information (step S118). Furthermore, the image generation unit 1022 generates the second partial image data which is acquired by superimposing the generated operation image data on the first partial image data (step S119).

The image generation unit 1022 passes the generated second partial image data to the communication control unit 1023. The communication control unit 1023 transmits the second partial image data, which is passed to the image generation unit 1022, to the projector 100 through the wireless communication unit 40 (step S120). In a case in which the transmission of the second partial image data ends, the control unit 20 determines whether or not an end operation of ending the application program 31 is input (step S121). In a case in which the end operation is input (step S121/YES), the control unit 20 ends the process flow. In addition, in a case in which the end operation is not input (step S121/NO), the control unit 20 returns to step S117 to detect the contact operation again (step S117).

The projector 100 receives the second partial image data, which is transmitted from the mobile terminal 10, by the wireless communication unit 156 (step S107). The second partial image data, which is received by the wireless communication unit 156, is passed to the display control unit 1133. In a case in which the second partial image data is acquired from the communication control unit 1132, the display control unit 1133 reads the location information from the storage unit 151. Furthermore, the display control unit 1133 passes the read location information to the image processing unit 1125, together with the second partial image data.

The image processing unit 1125 converts the size of the second partial image data into a size which is suitable for the resolution of the liquid crystal panel 112A. In addition, the image processing unit 1125 superimposes the second partial image data, on which the size conversion is performed, on the projection image data according to the location information which is acquired from the display control unit 1133.

The image processing unit 1125 performs drawing in the frame memory 126 such that the second partial image data is superimposed on a location in which the first partial image data of the projection image data is cut. Thereafter, the image data drawn in the frame memory 126 is drawn on the liquid crystal panel 112A of the light modulation device 112 under the control of the projection control unit 131, and the drawn image is projected onto the screen SC as the projection image through the projection optical system 113 (step S108).

Subsequently, the control unit 130 of the projector 100 determines whether or not the connection with the mobile terminal 10 is released (step S109). In a case in which it is determined that the connection with the mobile terminal 10 is released (step S109/YES), the control unit 130 ends the process flow. In addition, in a case in which it is determined that the connection with the mobile terminal 10 is not released (step S109/NO), the control unit 130 returns to step S107, and waits for the reception of the data from the mobile terminal 10 (step S107).

Hereinabove, as described above, in the third embodiment, first partial image data, which is the image data of the area of the projector 100 that is selected by the user, of the projection image which is projected onto the screen SC is transmitted to the selected mobile terminal 10. In addition, since the first partial image data, which is received from the projector 100, is displayed on the display panel 52 in the mobile terminal 10, it is possible for the user of the mobile terminal 10 to input an operation to the display panel 52 while referring to the first partial image.

The operation image data according to the operation performed by the user is generated in the mobile terminal 10, the operation image data is superimposed on the first partial image data, and the operation image data is transmitted to the projector 100 as the second partial image data. Therefore, it is possible for the projector 100 to superimpose the second projection image on the projection image through a simple process. Accordingly, is possible to project an image onto the screen SC through an intuitive operation input from the mobile terminal 10.

### Fourth Embodiment

A fourth embodiment of the invention will be described with reference to the accompanying drawing.

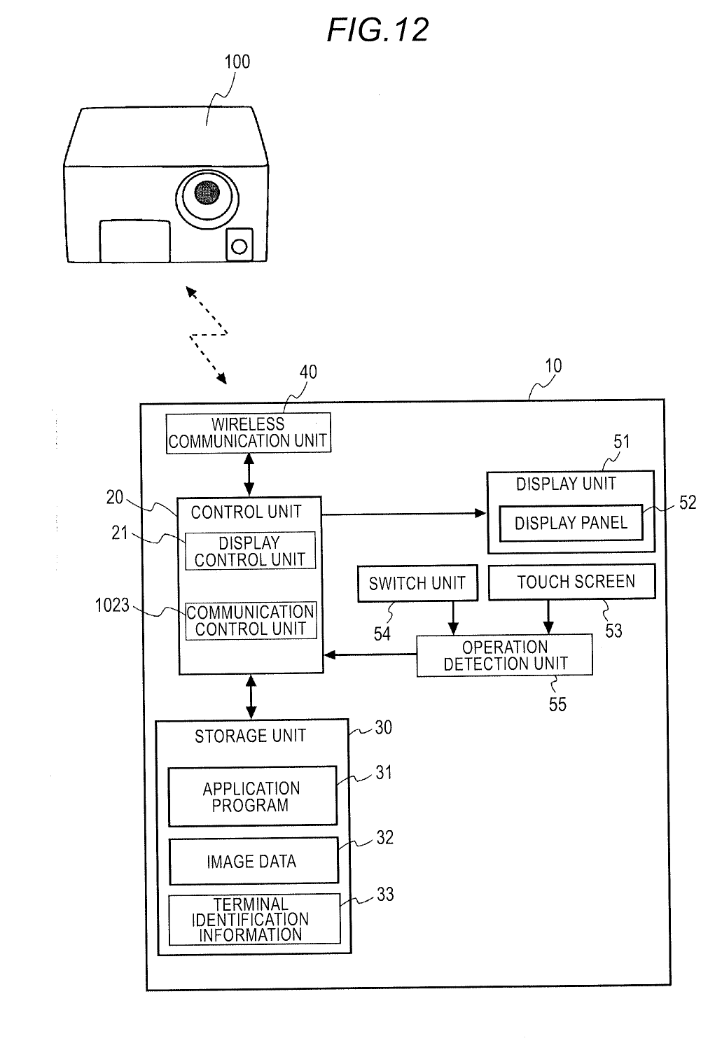

FIG. 12 illustrates an example of a configuration of a mobile terminal 10 according to the fourth embodiment. The mobile terminal 10 according to the fourth embodiment does not include the image generation unit 1022, compared with the mobile terminal 10 according to the third embodiment illustrated in FIG. 8. A display control unit 21 according to the fourth embodiment passes coordinate information (operation data), which indicates the operation location of the contact operation performed by a user, to a communication control unit 1132 as control data. The coordinate information is information which indicates coordinates on a touch screen 53. The communication control unit 1132 transmits the coordinate information to the projector 100 through the wireless communication unit 40.

In a case in which the control data is received from the mobile terminal 10, the display control unit 1133 of the projector 100 acquires the coordinate information from the received control data. The display control unit 1133 extracts the coordinate information from the acquired control data and reads resolution information 1512 from a storage unit 151.

The display control unit 1133 generates operation image data based on the coordinate information and the resolution information 1512. Since the coordinate information is the coordinate information of the display panel 52 (touch screen 53), the display control unit 1133 generates the operation image data using the resolution of the display panel 52 with reference to the resolution information 1512. Meanwhile, the operation image data is image data indicative of a traveling locus of a user finger, an electronic pen, or the like which performs the contact operation on the display surface of the display panel 52, and includes, for example, a letter, a figure, and the like. In a case in which the operation image data is generated, the display control unit 1133 reads location information from the storage unit 151. The location information is information indicative of a location in projection image data from which the partial image data is cut. The display control unit 1133 passes the operation image data to the image processing unit 1125, together with the location information.

The image processing unit 1125 converts the size of the operation image data, which is acquired from the display control unit 1133, into a size which is suitable for the resolution of the liquid crystal panel 112A. In addition, the image processing unit 1125 superimposes the operation image data, on which the size conversion is performed, on the projection image data according to the location information, which is acquired from the display control unit 1133. The image processing unit 1125 performs drawing in a frame memory 126 such that the operation image data is superimposed on the location of the projection image data from which the first partial image data is cut. Thereafter, the image data drawn in the frame memory 126 is drawn on the liquid crystal panel 112A of the light modulation device 112 under the control of a projection control unit 113, and the drawn image is projected onto the screen SC as the projection image through a projection optical system 113.

As described above, in the fourth embodiment, the coordinate information according to the operation performed by the user is generated in the mobile terminal 10, and transmitted to the projector 100. Accordingly, since the mobile terminal 10 may perform only a process of detecting the operation performed by the user and generating the coordinate information, the processing loads of the mobile terminal 10 are reduced. In addition, the projector 100 generates an image based on the coordinate information, which is acquired from the mobile terminal 10, and projects the generated image onto a specific location of the screen SC. Accordingly, it is possible to project the image onto the screen SC through intuitive operation input from the mobile terminal 10.

A display system 1 according to the fourth embodiment includes the projector 100 and the mobile terminal 10. The projector 100 displays an image on the screen SC based on the image data. The mobile terminal 10 includes the touch screen 53 which receives an operation, the operation detection unit 55 which detects an operation performed on the touch screen 53, and the display panel 52 which displays the image. The projector 100 transmits the image data corresponding to at least a part of the image, which is displayed on the screen SC, to the mobile terminal 10.

The mobile terminal 10 transmits the operation data corresponding to the location of the operation, which is detected by the operation detection unit 55, to the projector 100 while the image data corresponding to at least a part of the image is being displayed on the display panel 52. The projector 100 displays the image based on the operation data. Accordingly, in a configuration in which the mobile terminal 10 is separated from the projector 100, it is possible to enable the mobile terminal 10 to perform the intuitive operation input.

In the display system 1, the projector 100 associates at least a part of the image data, which is transmitted to the mobile terminal 10, with a display location on the screen SC. Furthermore, the projector 100 displays the image based on the operation data in the display location on the screen SC, which is associated with at least a part of the image data. Accordingly, it is possible to display the image according to the operation, which is received by the mobile terminal 10, in the display location of the image which is transmitted to the mobile terminal 10.

The display system 1 includes a plurality of mobile terminals 10. The projector 100 associates at least a part of image data, which are transmitted to the plurality of respective mobile terminals 10, with display locations on the screen SC. In a case in which the operation data are received from the mobile terminals 10, the projector 100 displays images based on the operation data in the display locations on the screen SC, which are associated with the image data corresponding to at least a part of the image which are transmitted to the mobile terminal 10. Accordingly, it is possible to display the images according to the operation data in the display locations of the screen SC according to the image data which are transmitted to the respective mobile terminal 10.

In the display system 1, the mobile terminal 10 transmits coordinate information on the display panel 52, which indicates an instruction location, to the projector 100 as the operation data. The projector 100 generates an image based on the coordinate information which is received from the mobile terminal 10, and displays the image on the screen SC. Accordingly, in a case in which the mobile terminal 10 transmits the coordinate information, the input of which is received, to the projector 100 without change, the image based on the coordinate information is displayed on the projector 100. Therefore, it is possible to reduce the processing loads of the mobile terminal 10.

In the display system 1, the mobile terminal 10 generates image data, which includes at least one of a letter and a figure, based on the operation performed on the touch screen 53, and transmits the generated image data to the projector 100 as the operation data. Accordingly, it is possible to generate the image data according to the operation, which is received in the mobile terminal 10, and to display the generated image data on the projector 100.

In the display system 1, the mobile terminal 10 generates image data, in which the generated image data is superimposed on at least apart of the image data, and transmits the generated image data to the projector 100. Accordingly, it is possible to superimpose the image, which is generated based on the operation which is received in the mobile terminal 10, on the image which is displayed on the projector 100, and to display the resulting image.

The above-described respective embodiments are embodiments which are suitable for the invention. However, the invention is not limited to the embodiments and various modifications are possible without departing from the gist of the invention. For example, in each of the embodiments, the front projection-type projector 100, which performs projection from the front side of the screen SC, is described as an example of the display device. However, the invention is not limited thereto. For example, it is possible to use a rear projection (rear-side projection)-type projector, which performs projection from the rear side of the screen SC, as the display device. In addition, a liquid crystal monitor or a liquid crystal television, which displays an image on a liquid crystal display panel, may be used as the display device.

A Plasma Display Panel (PDP), a Cathode-Ray Tube (CRT) display, a Surface-conduction Electron-emitter Display (SED), and the like may be used as the display device. In addition, a light emission-type display device, such as a monitor device or a television receiver, which displays an image on an organic EL display panel, called an Organic Light-Emitting Diode (OLED) or an Organic Electro Luminescence (OEL) display, may be used. In a case in which the invention is applied to a configuration which includes the display devices, effective advantages are also acquired similarly to the embodiments.

In addition, with regard to the input device according to the invention, in each of the embodiments, the mobile terminal 10, which is a small device that is operated by the user in hand as the input device, is described as an example of the input device. However, the invention is not limited thereto. That is, the mobile terminal 10 according to each of the embodiments includes the touch screen 53 and the display panel 52 which can be operated by the user by contacting a finger, and thus there are advantages in that it is possible to perform intuitive operation and high operability is provided. In contrast, the invention may be applied a device which includes the second display surface and the operation surface. For example, it is possible to use a mobile game machine, a mobile reproduction device which reproduces music and video, a remote controller device which includes a display screen, and the like as the input device.

In addition, in each of the embodiments, the wireless communication unit 156, which performs the reception of the coordinate information and the transmission of the image data, is described as an example of the first communication unit. However, the invention is not limited thereto. For example, a first communication unit may include a reception unit which receives the coordinate information and a transmission unit which transmits the image data, and the reception unit and the transmission unit may be configured to be independent from each other. The reception unit may perform at least one of the wired communication and the wireless communication, and the transmission unit may perform at least one of the wired communication and the wireless communication

In addition, in each of the embodiments, the wireless communication unit 40, which performs transmission of the coordinate information and reception of the image data, is described as an example of the second communication unit. However, the invention is not limited thereto. For example, the second communication unit may include a transmission unit which transmits the coordinate information and a reception unit which receives the image data, and the transmission unit and the reception may be configured to be independent from each other. The transmission unit may perform at least one of the wired communication and the wireless communication, and the reception unit may perform at least one of the wired communication and the wireless communication.

In addition, each of the functional units illustrated in FIGS. 2, 3, 8, and 9 illustrates the functional configuration, and detailed mounting forms are not particularly limited. That is, hardware individually corresponding to each of the functional units may not be necessarily mounted, and it is apparent that the functions of the plurality of functional units are configured to be realized in such a way that one processor executes a program. In addition, in the embodiments, a part of functions which are realized by software may be realized by hardware, and part of functions which are realized by hardware may be realized by software. In addition, the detailed configurations of other respective units of the display system 1 may be arbitrary changed without departing the gist of the invention.

### REFERENCE SIGNS LIST

1 . . . display system

10 . . . mobile terminal (input device, external device)

20 . . . control unit

21 . . . display control unit

22 . . . communication control unit

30 . . . storage unit

40 . . . wireless communication unit (second communication unit)

51 . . . display unit

52 . . . display panel (second display surface)

53 . . . touch screen (operation surface)

55 . . . operation detection unit (generation unit, detection unit)

100 . . . projector (display device)

110 . . . projection unit

112A . . . liquid crystal panel

125 . . . image processing unit

126 . . . frame memory

130 . . . control unit

131 . . . projection control unit

132 . . . communication control unit

133 . . . display control unit

151 . . . storage unit

153 . . . input processing unit

156 . . . wireless communication unit (first communication unit)

1022 . . . image generation unit

1023 . . . communication control unit

1125 . . . image processing unit

1132 . . . communication control unit

1133 . . . display control unit

1511 . . . terminal identification information

1512 . . . resolution information

1. A display system comprising:
a display device; and
an input device,
wherein the display device includes
a first communication unit that receives coordinate information which indicates an operation location on an operation surface of the input device; and
a display control unit that generates an image based on the coordinate information, which is received by the first communication unit, and displays the image on a first display surface, and
wherein the input device includes
a generation unit that detects an operation which is performed on the operation surface, and generates the coordinate information; and
a second communication unit that transmits the coordinate information which is generated by the generation unit.

2. The display system according to claim 1,
wherein the display device includes a storage unit that stores correspondence information for deciding correspondence between a display area of a second display surface included in the input device and a display area of the first display surface, and
wherein the display control unit generates the image based on the coordinate information according to the correspondence information, and displays the image on the first display surface.

3. The display system according to claim 1,
wherein the first communication unit transmits image data to the input device,
wherein the second communication unit receives the image data, and
wherein the input device includes a display unit that displays an image based on the image data, which is received in the second communication unit, on a second display surface which is disposed to be superimposed on the operation surface.

4. The display system according to claim 3,
wherein the display device transmits the image data corresponding to at least a part of the image, which is displayed on the first display surface, to the input device as the image data.

5. The display system according to claim 4,
wherein the display device transmits image data corresponding to a partial image, which is selected from the image that is displayed on the first display surface, to the input device.

6. The display system according to claim 3,
wherein the display device transmits image data, which indicates the display area of the first display surface on which the image based on the coordinate information is displayed, to the input device as the image data.

7. The display system according to claim 1,
wherein, in a case in which the coordinate information is operation information for enlarging or reducing the image, the display control unit enlarges or reduces the image which is displayed on the first display surface according to the operation information.

8-9. (canceled)

10. A display system comprising:
a display device; and
an input device,
wherein the display device includes
a first display unit that displays an image based on image data on a first display surface; and
a first communication unit that transmits the image data corresponding to at least a part of the image, which is displayed on the first display surface, to the input device,
wherein the input device includes
an operation surface that receives an operation;
a detection unit that detects the operation which is performed on the operation surface;
a second display unit that displays an image based on the image data corresponding to at least a part of the image, on the second display surface; and
a second communication unit that transmits operation data corresponding to an operation location, which is detected by the detection unit, to the display device while the image data corresponding to at least a part of the image is being displayed on the second display surface, and
wherein the display device displays the image based on the operation data on the first display surface.

11. The display system according to claim 10,
wherein the display device
associates the image data corresponding to at least a part of the image, which is transmitted to the input device, with a display location on the first display surface, and stores an association result, and
displays the image based on the operation data in the display location of the first display surface which is associated with the image data corresponding to at least a part of the image.

12. The display system according to claim 10,
wherein a plurality of input devices are provided,
wherein the display device associates the image data corresponding to at least a part of the image, which is transmitted to each of the input devices, with the display location on the first display surface, and stores an association result, and
in a case in which the operation data is received from the input device, displays the image based on the operation data in the display location on the first display surface that is associated with the image data corresponding to at least a part of the image which is transmitted to each of the input devices.

13. The display system according to claim 10,
wherein the input device transmits coordinate information on the operation surface, which indicates the operation location that is detected by the detection unit, to the display device as the operation data, and
wherein the display device generates an image based on the coordinate information which is received from the input device, and displays the image on the first display surface.

14. The display system according to claim 10,
wherein the input device generates image data, which includes at least one of a letter and a figure based on the operation that is performed on the operation surface, and transmits the generated image data to the display device as the operation data.

15. The display system according to claim 14,
wherein the input device transmits the generated image data to the display device by generating the image data which is superimposed on the image data corresponding to at least a part of the image.

16. (canceled)

17. A display method in a display system, which includes a display device and an input device, the display method comprising:
displaying an image based on image data on a first display surface in the display device;
transmitting the image data corresponding to at least a part of the image, which is displayed on the first display surface, to the input device;
displaying an image based on the image data corresponding to at least a part of the image on the second display surface in the input device;
detecting an operation which is performed on an operation surface that receives the operation while the image data corresponding to at least a part of the image is being displayed on the second display surface;
transmitting operation data corresponding to a detected operation location to the display device; and
displaying an image based on the operation data on the first display surface in the display device.
